(19) United States
(12) Patent Application Publication
(10) Pub. No.: US 2022/0200809 A1
(43) Pub. Date: Jun. 23, 2022

(54) MANAGEMENT SYSTEM, MANAGEMENT METHOD, UPPER BLOCK CHAIN CALCULATION DEVICE, AND PROGRAM

(71) Applicant: MITSUBISHI HEAVY INDUSTRIES, LTD., Tokyo (JP)

(72) Inventor: Kenji TAKAO, Tokyo (JP)

(21) Appl. No.: 17/603,143

(22) PCT Filed: Feb. 3, 2020
(86) PCT No.: PCT/JP2020/003903

§ 371 Date: Oct. 12, 2021

(30) Foreign Application Priority Data
Apr. 18, 2019 (JP) 2019-079326

(51) Int. Cl. H04L 9/32

(52) U.S. Cl. CPC H04L 9/3239; H04L 2209/38

(57) ABSTRACT

A management system includes: calculation devices of a plurality of lower block chains; and a calculation device of an upper block chain. Each of the calculation devices of the lower block chains includes: a data accepting unit configured to accept registration of transaction data; a first block data generating unit configured to generate first block data; a hash calculating unit configured to calculate a hash value of a block data group; a registration requesting unit configured to request registration of the hash value; and a deletion processing unit configured to delete all the first block data. The calculation device of the upper block chain includes: a registration accepting unit configured to accept a registration request for registering the hash value; a second block data generating unit configured to generate second block data; and a data verifying unit configured to determine presence or absence of invalidity in the first block data.

### TECHNICAL FIELD

The present invention relates to a management system, a management method, an upper block chain calculation device, and a program.

Priority is claimed on Japanese Patent Application No. 2019-079326, filed Apr. 18, 2019, the content of which is incorporated herein by reference.

### BACKGROUND ART

In recent years, systems using a distributed ledger technology such as a blockchain are known as data management systems having a high security level. A block chain has a structure in which a lump of data relating to transactions (transaction data) is set as one block, and such blocks are connected in a chained pattern in a time series and shared by a plurality of nodes on a network. A hash value of a previous block is included in each block. For this reason, an alteration of a block can be easily detected using consistency with a hash value included in a next block. Then, in order to make an alteration of one certain block, all the succeeding blocks increasing from moment to moment need to be changed, and thus it becomes very difficult to make an alteration of a block in a block chain. In the block chain, the security level is improved in this way.

In addition, although a block chain is also used for a transaction of virtual currency such as bit coins, a period for generating a block is about 10 minutes, which is long, and thus it is difficult to respond to a demand for completing a transaction in a short time. For this reason, a technology in which a block chain (a side chain) other than a main block chain in which a block generation period is long is prepared, a transaction requiring high-speed processing is managed by the side chain, and a hash value of information managed by the side chain is regularly managed by an upper block chain may be considered (for example, see Patent Literature 1).

### CITATION LIST

### Patent Literature

[Patent Literature 1]

Japanese Unexamined Patent Application, First Publication No. 2018-18348

### SUMMARY OF INVENTION

### Technical Problem

When a system using a block chain is operated once, from the nature of matching hash values between consecutive blocks, it is difficult to delete past transaction data. For this reason, in a case in which a total data volume of blocks becomes larger than a storage capacity of each node, all the blocks need to be deleted, or a new block chain needs to be prepared.

In addition, as in Patent Literature 1 described above, in a case in which a plurality of block chains including the main block chain and the side chain are operated, the data volume store in each block chain can be decreased. However, there still is a limit on the storage capacity of each node, and thus, for example, in a case in which a total data volume of blocks becomes larger than the storage capacity of each node in the side chain, all the blocks need to be deleted, or a new block chain needs to be prepared. Thus, in a system using a block chain of the related art, it becomes difficult to continuously manage data for a long period, or the length of the chain becomes short at the time of switching to another side chain, and thus there is a likelihood of being easily attacked.

At least one embodiment of the present invention is in view of such problems and provides a management system, a management method, an upper block chain calculation device, and a program capable of deleting past data and continuously managing data for a long period in a state in which the security level is maintained.

### Solution to Problem

According to a first aspect of the present invention, a management system includes: calculation devices of a plurality of lower block chains; and a calculation device of an upper block chain. Each of the calculation devices of the plurality of the lower block chains includes: a data accepting unit configured to accept registration of transaction data; a first block data generating unit configured to generate first block data including the accepted transaction data; a hash calculating unit configured to calculate a hash value of a block data group formed from at least one piece of the first block data; a registration requesting unit configured to request registration of the hash value of the block data group to the calculation device of the upper block chain; and a deletion processing unit configured to delete all the first block data of one of the lower block chains at a predetermined timing. The calculation device of the upper block chain includes: a registration accepting unit configured to accept a registration request for registering the hash value of the block data group from the calculation devices of the plurality of the lower block chains; a second block data generating unit configured to generate second block data including the accepted hash value of the block data group; and a data verifying unit configured to perform a determination process of determining presence or absence of invalidity in a plurality of pieces of the first block data other than deleted first block data on the basis of the hash value of the block data group included in the second block data.

According to a second aspect of the present invention, in the management system according to the first aspect, each of the calculation devices of the plurality of the lower block chains includes a notification processing unit configured to notify the calculation device of the upper block chain of deletion of the first block data. The data verifying unit of the calculation device of the upper block chain performs the determination process for a plurality of pieces of the first block data other than the first block data of which deletion has been notified by the notification processing unit.

According to a third aspect of the present invention, in the management system according to the first or second aspect, the second block data further includes a block ID that can be used for identifying the first block data, the calculation device of the upper block chain further includes a hash acquiring unit configured to acquire the hash value of the block data group including the first block data identified by the block ID from the calculation device of the lower block chain, and, in a case in which the hash value of the block data group included in the second block data and the hash value of the corresponding block data group acquired by the hash acquiring unit do not coincide with each other, the data verifying unit determines that the first block data included in the corresponding block data group is invalid.

According to a fourth aspect of the present invention, in the management system according to any one of the first to third aspects, each of the calculation devices of at least two lower block chains accepts the same transaction data.

According to a fifth aspect of the present invention, in the management system according to any one of the first to fourth aspects, when the first block data is deleted, the calculation device of one of the lower block chains requests registration of the transaction data satisfying a predetermined condition to the calculation device of another lower block chain as new transaction data.

According to a sixth aspect of the present invention, in the management system according to the fifth aspect, each of the calculation devices of the plurality of the lower block chains further accepts registration of information indicating deletion prohibition or non-deletion prohibition of the transaction data and determines that the condition is satisfied in a case that the information indicating deletion prohibition is registered for the transaction data.

According to a seventh aspect of the present invention, a management method using calculation devices of a plurality of lower block chains and a calculation device of an upper block chain includes: steps performed by each of the calculation devices of the plurality of the lower block chains, the steps including: accepting registration of transaction data; generating first block data including the accepted transaction data; calculating a hash value of a block data group formed from at least one piece of the first block data; requesting the calculation device of the upper block chain to register the hash value of the block data group; and deleting the first block data at a predetermined timing, and steps performed by the calculation device of the upper block chain, the steps including: accepting a registration request for registering the hash value of the block data group from the calculation devices of the plurality of the lower block chains; generating second block data including the accepted hash value of the block data group; and determining presence or absence of invalidity in a plurality of pieces of the first block data other than deleted first block data on the basis of the hash value of the block data group included in the second block data.

According to an eight aspect of the present invention, a calculation device of an upper block chain includes: a registration accepting unit configured to accept a registration request for registering a hash value of a block data group formed from at least one piece of first block data including transaction data accepted by a calculation device of a lower block chain; a second block data generating unit configured to generate second block data including the accepted hash value of the block data group; and a data verifying unit configured to determine presence or absence of invalidity in a plurality of pieces of the first block data other than deleted first block data on the basis of the hash value relating to the first block data included in the second block data.

According to a ninth aspect of the present invention, a program causes a computer of a calculation device of an upper block chain to function, the program causing the computer to execute: a step of accepting a registration request for registering a hash value of a block data group formed from at least one piece of first block data including transaction data accepted by a calculation device of a lower block chain; a step of generating second block data including the accepted hash value of the block data group; and a step of determining presence or absence of invalidity in a plurality of pieces of the first block data other than deleted first block data on the basis of the hash value relating to the first block data included in the second block data.

### Advantageous Effects of Invention

According to at least one of the aspects described above, past data can be deleted, and data management can be continuously performed for a long period in a state in which the security level is maintained.

### BRIEF DESCRIPTION OF DRAWINGS

FIG. 1 is a diagram illustrating the entire configuration of a management system according to a first embodiment.

FIG. 2 is a diagram illustrating the functional configuration of a calculation device of a lower block chain according to the first embodiment.

FIG. 3 is a diagram illustrating an example of first block data and transaction data according to the first embodiment.

FIG. 4 is a diagram illustrating the functional configuration of a calculation device of an upper block chain according to the first embodiment.

FIG. 5 is a diagram illustrating an example of second block data according to the first embodiment.

FIG. 6 is a first flowchart illustrating an example of a process of the lower block chain according to the first embodiment.

FIG. 7 is a diagram illustrating the function of the lower block chain according to the first embodiment.

FIG. 8 is a second flowchart illustrating an example of a process of the lower block chain according to the first embodiment.

FIG. 9 is a first flowchart illustrating an example of a process of the upper block chain according to the first embodiment.

FIG. 10 is a diagram illustrating the function of the upper block chain according to the first embodiment.

FIG. 11 is a second flowchart illustrating an example of a process of the upper block chain according to the first embodiment.

FIG. 12 is a flowchart illustrating an example of a process of the lower block chain according to the second embodiment.

FIG. 13 is a diagram illustrating an example of the hardware configuration of a calculation device according to at least one of the embodiments.

### DESCRIPTION OF EMBODIMENTS

### First Embodiment

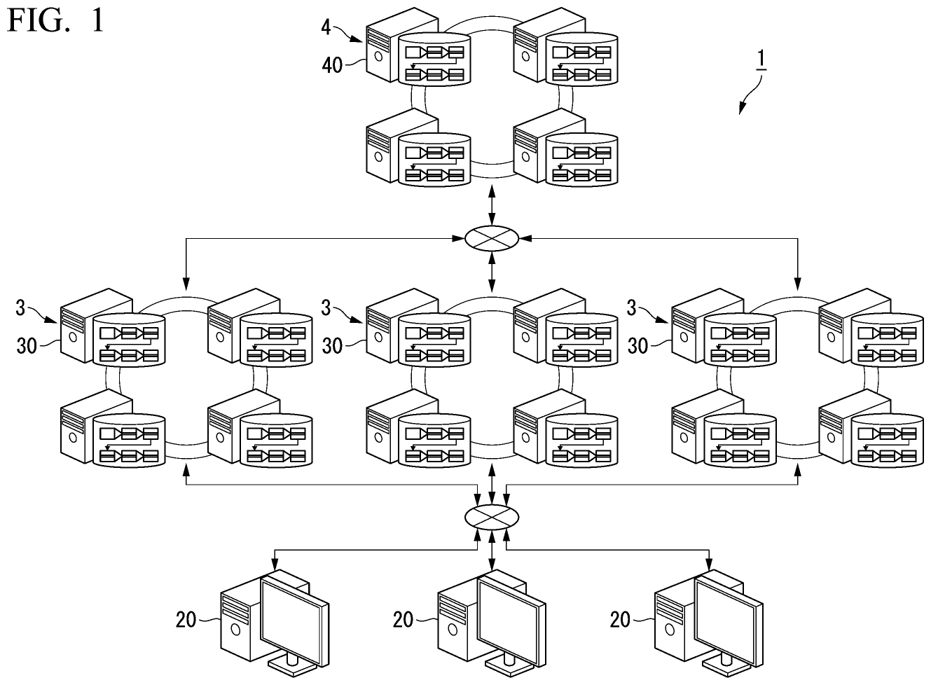

Hereinafter, a management system 1 and a management method according to a first embodiment of the present invention will be described with reference to FIGS. 1 to 11.

### Entire Configuration

FIG. 1 is a diagram illustrating the entire configuration of a management system according to a first embodiment.

As illustrated in FIG. 1, the management system 1 includes calculation devices 30 composing a plurality of lower block chains 3 and calculation devices 40 composing upper block chains 4. The lower block chains 3 and the upper block chains 4 form one type of distributed ledger system connected through a network.

Each of the lower block chains 3 is composed of a plurality of nodes. For example, a node is a calculation device 30 that sequentially accepts registration of transaction data from a client 20 accepting an operation from a user of the management system 1 and generates a “block” including the accepted transaction data. The client 20 is a computer such as a personal computer, a smartphone, a tablet, or the like. The transaction data is data in which details of various transactions executed by a user through the client 20 are recorded. In this embodiment, a “block” generated by the lower block chain 3 will also be referred to as “first block data.”

Although an example in which the management system 1 includes three lower block chains 3 is illustrated in FIG. 1, the number of lower block chains that are included is not limited thereto. The number of lower block chains 3 may be further increased in accordance with details and a data volume of transaction data. In addition, although an example in which each lower block chain 3 includes four calculation devices 30 is illustrated in FIG. 1, the number of calculation devices 30 that are included is not limited thereto. Each lower block chain 3 may include two, four, or more calculation devices 30 as nodes.

Similar to the lower block chain 3, the upper block chain 4 is composed of a plurality of nodes. A node is a calculation device 40 that accepts registration of data from a plurality of lower block chains and generates a “block” including the accepted data. In this embodiment, a “block” generated by the upper block chain 4 will also be referred to as “second block data.”

Although an example in which the upper block chain 4 includes four calculation devices 40 is illustrated in FIG. 1, the number of calculation devices 40 that are included is not limited thereto. The upper block chain 4 may include two, four, or more calculation devices 40 as nodes.

### Functional Configuration of Lower Block Chain

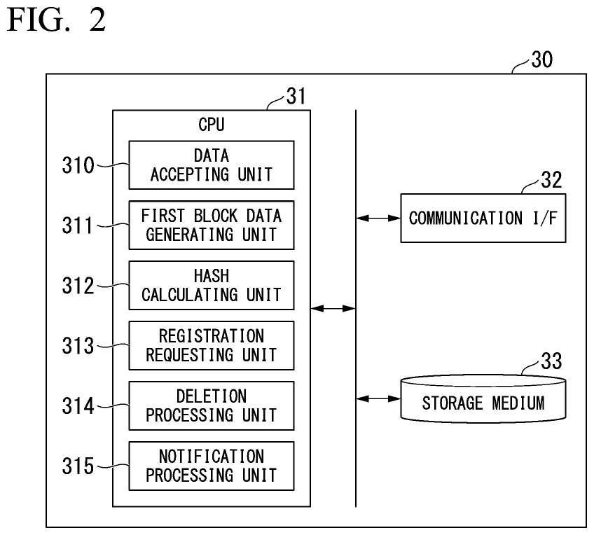

FIG. 2 is a diagram illustrating the functional configuration of a calculation device of a lower block chain according to the first embodiment.

As illustrated in FIG. 2, the calculation device 30 of the lower block chain 3 includes a CPU 31, a communication I/F 32, and a storage medium 33.

The CPU 31 is a processor that is responsible for the overall operation of the calculation device 30 and operates in accordance with a predetermined program, thereby exhibiting functions of a data accepting unit 310, a first block data generating unit 311, a hash calculating unit 312, a registration requesting unit 313, a deletion processing unit 314, and a notification processing unit 315.

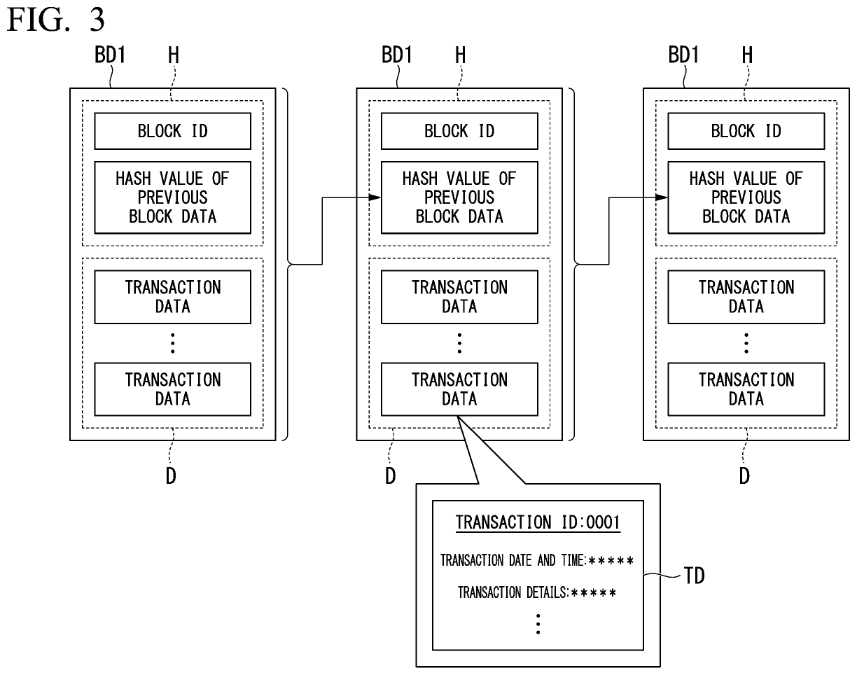

The data accepting unit 310 accepts registration of transaction data TD (FIG. 3) from a client 20. The transaction data TD is data in which transaction details are recorded by a user.

FIG. 3 is a diagram illustrating an example of the first block data and the transaction data according to the first embodiment.

As illustrated in FIG. 3, for example, a “transaction ID” used for identifying a transaction and a “transaction date and time,” “transaction details,” and the like representing transaction details are included in the transaction data TD. In the transaction details, a transaction target (a product, a service, or the like), the amount of money, and information that can be used for identifying a user (a user ID, a user name, a contact address, and the like) may be included.

The first block data generating unit 311 generates first block data BD1 (FIG. 3) including the transaction data TD that has been accepted by the data accepting unit 310. In addition, for example, the first block data BD1 generated by the first block data generating unit 311 of a certain calculation device 30 is stored in the storage medium 33 of this calculation device 30 and is transmitted to another calculation device 30 belonging to the same lower block chain 3. In addition, each calculation device 30 mutually checks the validity of the first block data BD1 received from another calculation device 30. For example, in this embodiment, when the first block data BD1 that has been newly generated is approved by a predetermined number or more of calculation devices 30 (for example 2/3), this first block data BD1 is connected and added to the block chain as a latest block for each calculation device 30. In this way, a plurality of calculation devices 30 belonging to the same lower block chain 3 can share a plurality of pieces of first block data BD1 connected in a chained pattern as a block chain.

As illustrated in FIG. 3, the first block data BD1 includes a header part H including a “block ID” that is identification information of the first block data BD1, a “hash value” of the first block data BD1 that has been previously generated, and a body part D including at least one piece of “transaction data.” In accordance with this, a plurality of pieces of first block data BD1 are connected in a time series using hash values of respective previous first block data BD1 included in each header part H. For this reason, in order to make an alteration of the first block data BD1 without any contradiction, all the other first block data connected to the first block data BD1 needs to be altered. In addition, after the first block data BD1 generated for a certain calculation device 30 is immediately transmitted to another calculation device 30, the validity thereof is mutually checked. In accordance with such a structure, it is extremely difficult for a third party to alter data registered in the lower block chain 3.

The hash calculating unit 312 calculates a hash value of a block data group formed from at least one piece of the first block data BD1. In addition, the hash calculating unit 312 recalculates a hash value of a block data group including the first block data BD1 requested from the upper block chain 4 and outputs the recalculated hash value to the upper block chain 4.

The registration requesting unit 313 requests the upper block chain 4 to register the hash value of the block data group calculated by the hash calculating unit 312.

The deletion processing unit 314 deletes all the first block data BD1 at a predetermined timing, thereby clearing data that is managed and shared by the calculation devices 30 within the lower block chain 3.

The notification processing unit 315 notifies the calculation device 40 of the upper block chain 4 of the deletion of all the first block data BD1.

The communication I/F 32 transmits/receives various kinds of information to/from the client 20, the calculation device 40 of the upper block chain 4, and other calculation devices 30 belonging to the same lower block chain 3 as that of its own device.

In the storage medium 33, the transaction data TFD accepted from the client 20, the first block data BD1 shared with other calculation devices 30 belonging to the same lower block chain 3 as that of its own device, and the like are stored.

### Functional Configuration of Upper Block Chain

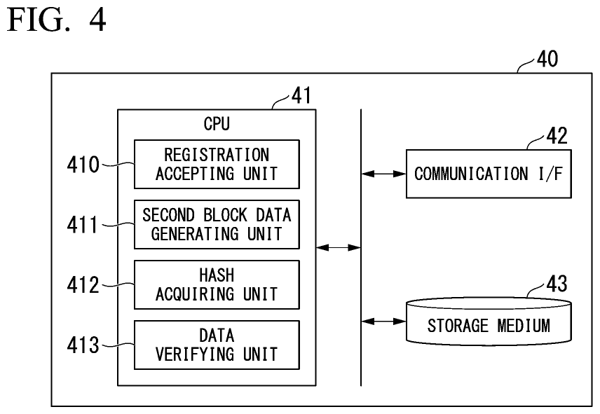

FIG. 4 is a diagram illustrating the functional configuration of a calculation device of an upper block chain according to the first embodiment.

As illustrated in FIG. 4, the calculation device 40 of the upper block chain 4 includes a CPU 41, a communication I/F 42, and a storage medium 43.

The CPU 41 is a processor that is responsible for the overall operation of the calculation device 40 and operates in accordance with a predetermined program, thereby exhibiting functions of a registration accepting unit 410, a second block data generating unit 411, a hash acquiring unit 412, and a data verifying unit 413.

The registration accepting unit 410 accepts a request for registering a hash value of a block data group from the calculation device 30 of the lower block chain 3.

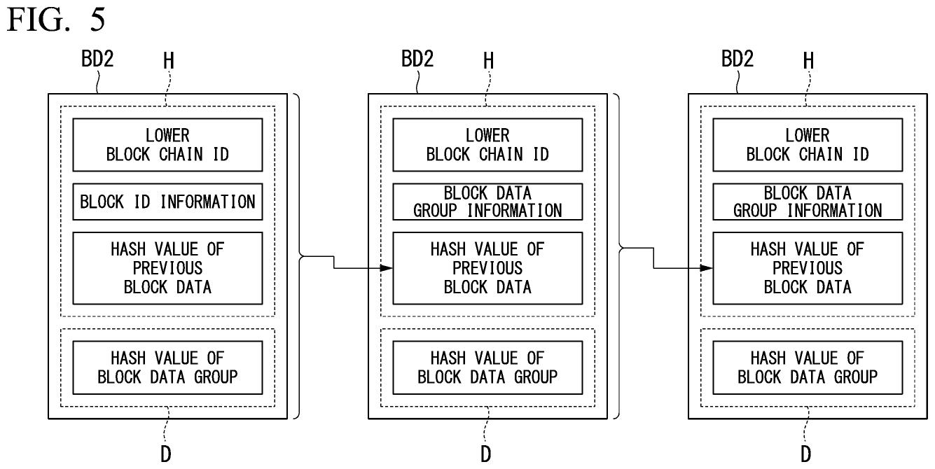

The second block data generating unit 411 generates second block data BD2 (FIG. 5) including a hash value of a block data group. In addition, for example, the second block data BD2 generated by the second block data generating unit 411 of a certain calculation device 40 is stored in the storage medium 43 of this calculation device 40 and is transmitted to another calculation device 40 belonging to the upper block chain 4. In addition, each calculation device 40 mutually checks the validity of the second block data BD2 received from another calculation device 40. For example, in this embodiment, when the second block data BD2 that has been newly generated is approved by a predetermined number or more of calculation devices 40 (for example 2/3), this second block data BD2 is connected and added to the block chain as a latest block for each calculation device 40. In this way, a plurality of calculation devices 40 belonging to the upper block chain 4 can share a plurality of pieces of second block data BD2 connected in a chained pattern as a block chain.

FIG. 5 is a diagram illustrating an example of the second block data according to the first embodiment.

As illustrated in FIG. 5, the second block data BD2 includes a header part H and a body part D. In the body part D, “a hash value of the block data group” requested to be registered by the calculation device 30 of the lower block chain 3 is included. In the header part H, a “lower block chain ID” that is identification information that can be used for identifying the lower block chain 3 to which the calculation device 30 that has requested registration belongs, “block ID information” representing a block ID of first block data BD1 included in the block data group, and a “hash value” of the second block data BD2 that has been previously generated are included. In accordance with this, a plurality of pieces of second block data BD2 are connected in a time series in accordance with a hash value of the previous second block data BD2 included in each header part H. As described above, the second block data is transmitted by a plurality of calculation devices 40 of the upper block chain, and thus it is extremely difficult for a third party to alter the second block data.

The hash acquiring unit 412 acquires a hash value of a block data group including the first block data BD1 identified by the “block ID information” included in the second block data BD2 (the header part H) from the calculation device 30 of the lower block chain 3.

The data verifying unit 413 determines presence or absence of an alteration in a plurality of pieces of first block data BD1 other than the deleted first block data BD1 on the basis of a hash value relating to the first block data BD1 included in the second block data BD2 (the body part D). More specifically, in a case in which a hash value of the block data group included in the second block data BD2 (the body part D) and a hash value of a corresponding block data group acquired by the hash acquiring unit 412 do not coincide with each other, the data verifying unit 413 determines that the first block data BD1 included in the corresponding block data group has been altered.

The communication I/F 42 transmits/receives various kinds of information to/from the calculation devices 30 of a plurality of lower block chains 3 and other calculation devices 40 belonging to the upper block chain.

In the storage medium 43, the second block data BD2 shared by a plurality of calculation devices 40 and the like are stored.

### Process Flow of Lower Block Chain

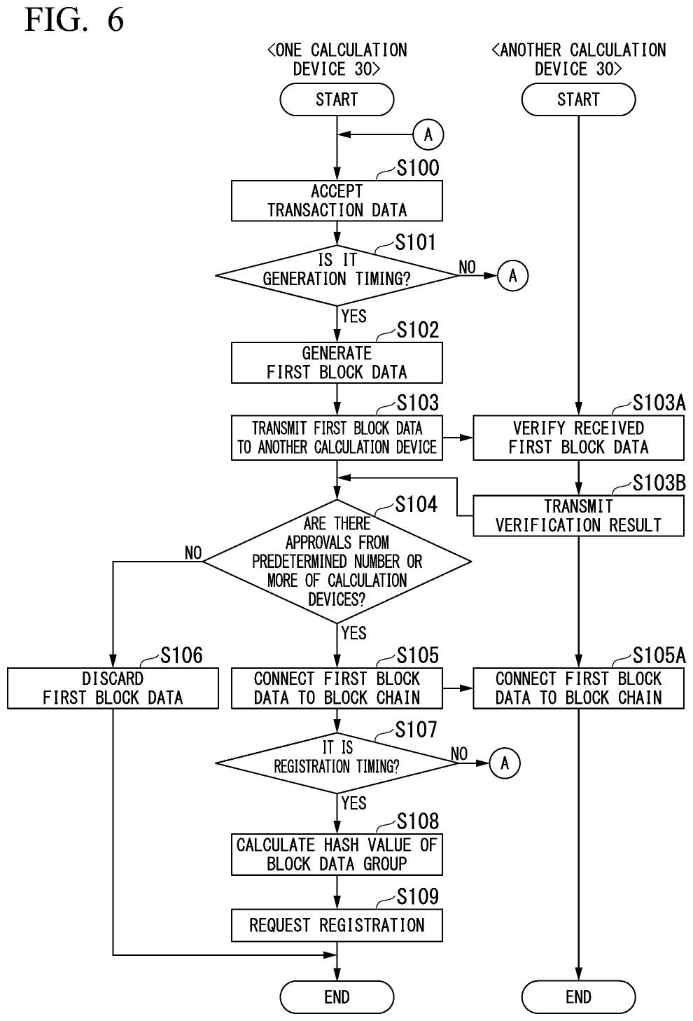

FIG. 6 is a first flowchart illustrating an example of a process of the lower block chain according to the first embodiment.

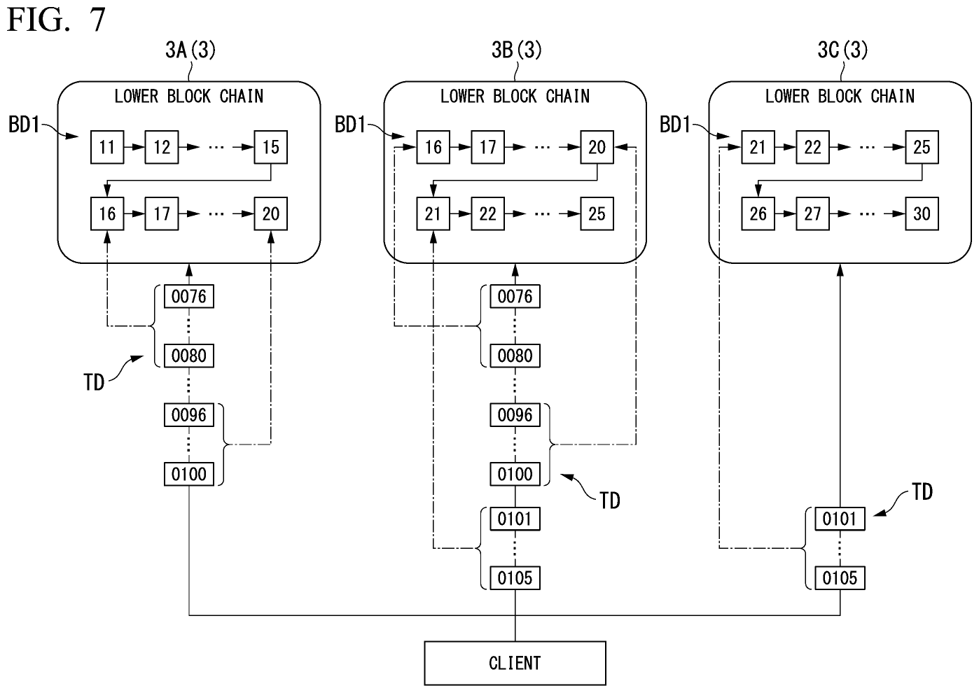

FIG. 7 is a diagram illustrating the function of the lower block chain according to the first embodiment.

Hereinafter, an example of a process of registering the transaction data TD and the first block data BD1 in the lower block chain 3 will be described with reference to FIGS. 6 and 7. In the following description, as illustrated in FIG. 7, a form in which the management system 1 includes three lower block chains 3A, 3B, and 3C will be described as an example. Here, a form in which one calculation device 30 among calculation devices 30 composing the lower block chain 3 generates first block data BD1, and another calculation device 30 checks the validity of the generated first block data BD1 will be described as an example.

First, as illustrated in FIG. 6, in each lower block chain 3, the data accepting unit 310 of one calculation device 30 accepts registration of transaction data TD from a client 20 (Step S100). In addition, the data accepting unit 310 stores and accumulates the accepted transaction data TD in the storage medium 33.

As illustrated in FIG. 7, in this embodiment, the calculation devices 30 of two lower block chains 3 among a plurality of lower block chains 3 accept the same transaction data TD from a certain client 20.

For example, in FIG. 7, an example in which transaction data TD is allocated to each lower block chain 3 such that a predetermined number of pieces of first block data BD1 are stored in duplicate in each calculation device of the two lower block chains 3 is illustrated. In the example illustrated in FIG. 7, five pieces of transaction data TD are assumed to be included in one piece of first block data BD1, and 10 pieces of first block data BD1 are assumed to be stored in each lower block chain 3. At this time, transaction data TD (transaction IDs: “0076” to “0100”) is allocated to the lower block chains 3A and 3B such that five pieces of first block data BD1 represented by block IDs “16” to “20” are stored in duplicate in the lower block chains 3A and 3B. In addition, transaction data TD (transaction ID “0101” and subsequent transaction IDs) is allocated to the lower block chains 3A and 3B such that five pieces of first block data BD1 represented by block IDs “21” to “25” are stored in duplicate in the lower block chains 3B and 3C.

Furthermore, in another embodiment, each calculation device 30 of two lower block chains 3 determined in advance for each time (for example, each date, each month, or each year) may be configured to accept transaction data TD.

Next, the first block data generating unit 311 of one calculation device 30 determines whether or not it is a timing for generating first block data BD1 (Step S101). For example, the first block data generating unit 311 may be configured to generate first block data BD1 in a case in which a predetermined number of pieces of transaction data TD have been accepted or may be configured to generate first block data BD1 for every predetermined time. Here, a form in which the first block data generating unit 311 generates first block data BD1 in a case in which five pieces of transaction data TD have been accepted. Thus, the first block data generating unit 311 determines whether or not five pieces of transaction data TD have been newly accepted after generating the previous first block data BD1 (Step S101).

In a case in which the number of pieces of transaction data TD that have been accepted after generation of the previous first block data BD1 is smaller than five (Step S101: No), the first block data generating unit 311 causes the process to return to Step S100 and waits for further accepting transaction data TD.

On the other hand, in a case in which the number of pieces of transaction data TD that have been accepted after generation of the previous first block data BD1 becomes five (Step S101: Yes), the first block data generating unit 311 generates first block data BD1 on the basis of these five pieces of transaction data TD (Step S102).

For example, in the example illustrated in FIG. 7, the first block data generating unit 311 of one calculation device 30 of the lower block chain 3A generates first block data BD1 formed form a header part H (FIG. 3) including a block ID (“20”) and a hash value of the first block data BD1 that has been previously generated and a body part D (FIG. 3) including five pieces of transaction data TD represented by transaction IDs “0096” to “0100”. Similarly, the first block data generating unit 311 of one calculation device 30 of the lower block chain 3B generates first block data BD1 (a block ID “20”) as well.

Next, each calculation device 30 verifies whether it is allowed to connect the first block data BD1 generated in Step S102 to the block chain as a valid block using a known agreement formation algorithm (for example, “PoW: Proof of Work”, “PoS: Proof of Stake”, or the like). More specifically, one calculation device 30 transmits the first block data BD1 generated in Step S102 to another calculation device 30 (Step S103). In that case, the other calculation device 30 verifies the validity of the received first block data BD1 (Step S103A). For example, the other calculation device 30 verifies a connection between hash values of the first block data BD1 that was connected in the past as the block chain and the first block data BD1 that has been newly generated (received). In addition, the other calculation device 30 transmits a result of the verification representing whether or not the newly-generated first block data BD1 is to be approved as a valid block to one calculation device 30 (Step S103B).

Next, in a case in which results of the verification representing approval of the first block data BD1 have been received from a predetermined number (for example, 2/3) or more of calculation devices 30 (Step S104: Yes), the first block data generating unit 311 connects this first block data BD1 to the block chain as a latest block (Step S105). In addition, similarly, also in another calculation device 30, a process of connecting this first block data BD1 to the block chain as a latest block is performed (Step S105A). In accordance with this, the first block data BD1 is shared by the calculation devices 30 of the lower block chain 3.

On the other hand, in a case in which there are results of the verification indicating approval of the first block data BD1 less than the predetermined number (Step S104: No), the first block data generating unit 311 discards this first block data BD1 (Step S106).

Next, the registration requesting unit 313 of one calculation device 30 determines whether or not it is a timing for registering a hash value of the block data group (Step S107).

For example, the registration requesting unit 313 may be configured to request registration of a hash value of a block data group for every predetermined time or may be configured to request registration of a hash value of a block data group every time when a predetermined number of pieces of first block data BD1 are generated. Here, a form in which registration of a hash value of a block data group is requested every time when five pieces of first block data BD1 are generated is employed. Thus, the registration requesting unit 313 determines whether or not five pieces of first block data BD1 have been generated after a previous registration request is performed (Step S107).

In a case in which the number of pieces of first block data BD1 generated after the previous registration request is less than 5 (Step S107: No), the registration requesting unit 313 returns the process to Step S100 and waits until additional first block data BD1 is generated.

On the other hand, in a case in which the number of pieces of first block data BD1 generated after the previous registration request becomes 5 (Step S107: Yes), the registration requesting unit 313 requests the hash calculating unit 312 to calculate a hash value of a block data group formed from these five pieces of the first block data BD1. In that case, the hash calculating unit 312 calculates the hash value of this block data group and outputs the calculated hash value to the registration requesting unit 313 (Step S108).

Next, the registration requesting unit 313 requests the upper block chain 4 to register the hash value of the block data group calculated by the hash calculating unit 312 (Step S109). At this time, the registration requesting unit 313 transmits the hash value of the block data group, identification information of the lower block chain 3 to which it belongs (a lower block chain ID), and block ID information including block IDs of the first block data BD1 included in the block data group (for example, “16” to “20”) to the calculation device 40 of the upper block chain 4 in association with each other.

The calculation device 30 of each of a plurality of lower block chains 3 registers the transaction data TD and the first block data BD1 by repeatedly performing the series of processes described above constantly and registers a hash value of a block data group formed from a plurality of pieces of the first block data BD1 in the calculation device 40 of the upper block chain 4. In addition, although FIG. 6 illustrates an example in which first block data BD1 is generated for one calculation device 30 belonging to the lower block chain 3, and the validity of the generated first block data BD1 is checked by another calculation device 30, the configuration is not limited thereto. In another embodiment, a plurality of calculation devices 30 may be formed to generate first block data BD1 in parallel. In such a case, one calculation device 30 that has generated first block data BD1 the earliest may be configured to transmit this first block data BD1 to another calculation device 30 and cause the other calculation device to check the validity.

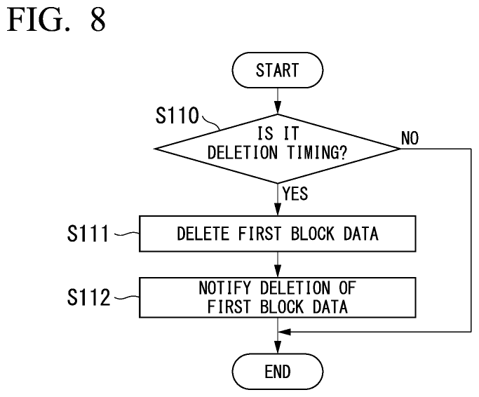

FIG. 8 is a second flowchart illustrating an example of a process of the lower block chain according to the first embodiment.

Hereinafter, an example of a process for deleting the transaction data TD and the first block data BD1 in the calculation device 30 of the lower block chain 3 will be described in detail with reference to FIG. 8. In addition, in description presented below, an example in which one calculation device 30 of the lower block chain 3A performs a corresponding process will be described.

First, as illustrated in FIG. 8, the deletion processing unit 314 of the calculation device 30 of a lower block chain 3A determines whether or not it is a timing for deleting the first block data BD1 (Step S110).

For example, in a case in which a predetermined time has elapsed, the deletion processing unit 314 may be configured to delete the first block data BD1. In addition, in a case in which the number of pieces of the first block data BD1 has reached a predetermined upper limit value (for example, 1000), the deletion processing unit 314 may be configured to delete the first block data BD1. Here, a form in which the deletion processing unit 314 sets a storage term (for example, 10 years) to the transaction data TD in advance and deletes the first block data BD1 in a case in which a time equal to or longer than the storage term (hereinafter referred to as a predetermined time) has elapsed after connection of latest first block data BD1 to the block chain (shared within the lower block chain 3A) is assumed.

In a case in which the predetermined time has not elapsed after connection of latest first block data BD1 to the block chain (Step S110: No), the deletion processing unit 314 ends the process.

On the other hand, in a case in which the predetermined time has elapsed after connection of latest first block data BD1 to the block chain (Step S110: Yes), the deletion processing unit 314 deletes all the first block data BD1 shared among the calculation devices 30 of the lower block chain 3A (Step S111).

Next, the notification processing unit 315 notifies the calculation device 40 of the upper block chain 4 of deletion of all the first block data BD1 of the lower block chain 3A (Step S112). At this time, the notification processing unit 315 notifies the calculation device 40 of the upper block chain 4 of the identification information (a lower block chain ID) of the lower block chain 3A for which the deletion has been performed and block IDs (for example, “11” to “20”) of the deleted first block data BD1 (in other words, all the first block data BD1 shared in the lower block chain 3A). In accordance with this, the calculation device 40 of the upper block chain 4 can perceive that all the first block data BD1 has been deleted in a certain lower block chain 3 and identify the deleted first block data BD1 from the block IDs.

The calculation device 30 of each of a plurality of lower block chains 3 repeatedly performs the series of processes described above constantly and deletes all the first block data BD1 at a predetermined timing. In FIG. 8, although an example in which the same storage term is set to each lower block chain 3 has been described, the configuration is not limited thereto. Different predetermined times may be respectively set to lower block chains 3. In addition, the deletion processing unit 314 may determine a deletion timing on the basis of both a predetermined time and an upper limit value of the first block data.

### Process Flow of Upper Block Chain

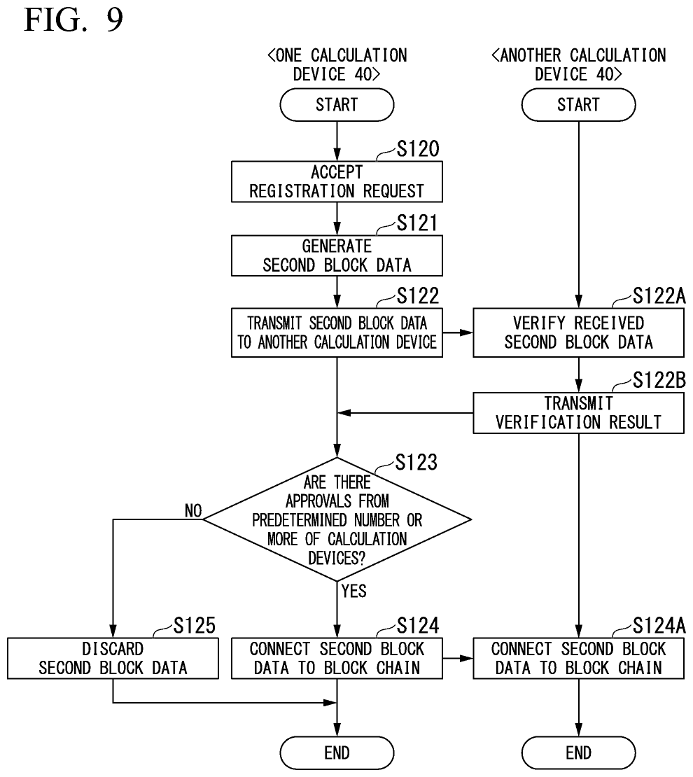

FIG. 9 is a first flowchart illustrating an example of a process of the upper block chain according to the first embodiment.

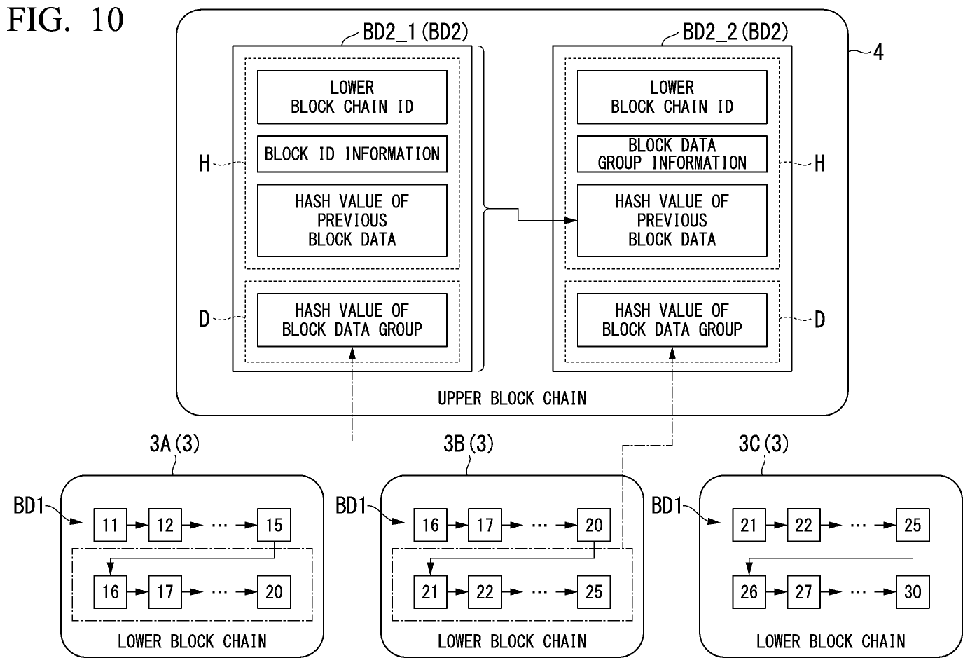

FIG. 10 is a diagram illustrating the function of the upper block chain according to the first embodiment.

Hereinafter, an example of a process for registering second block data BD2 in the calculation device 40 of the upper block chain 4 will be described in detail with reference to FIGS. 9 and 10. Here, a form in which one calculation device 40 among calculation devices 40 composing the upper block chain 4 generates second block data BD2, and another calculation device 40 checks the validity of the generated second block data BD2 will be described as an example.

First, as illustrated in FIG. 9, the registration accepting unit 410 of one calculation device 40 of the upper block chain 4 accepts a request for registering a hash value of a block data group from the calculation device 30 of the lower block chain 3 (Step S120).

Next, the second block data generating unit 411 generates second block data BD2 (FIG. 5) including the hash value of the block data group that has been accepted from the calculation device 30 of the lower block chain 3 (Step S121). A registration request includes identification information (a lower block chain ID) of a lower block chain 3 that is a transmission source and block ID information representing block IDs of first block data BD1 included in the block data group. The second block data generating unit 411 generates second block data BD2 formed from a header part H (FIG. 5) including a lower block chain ID, block ID information, and a hash value of the second block data BD2 that has been previously generated and a body part D (FIG. 5) including a hash value of the block data group.

For example, as illustrated in FIG. 10, it is assumed that the registration accepting unit 410 has accepted a request for registering first block data BD1 (block IDs “16” to “20”) from the calculation device 30 of the lower block chain 3A. In this case, the second block data generating unit 411 generates second block data BD2_1 including a header part H that includes a lower block chain ID of this lower block chain 3A, block information representing block IDs “16” to “20”, and a hash value of the second block data BD2 that has previously been generated and a body part D that includes a hash value of a block data group formed from the first block data BD1 of the block IDs “16” to “20”.

In addition, next, the registration accepting unit 410 is assumed to have accepted a request for registering first block data BD1 (block IDs “21” to “25”) from the lower block chain 3B. In this case, the second block data generating unit 411 generates second block data BD2_2 including a header part H that includes a lower block chain ID of this lower block chain 3B, block information representing block IDs “21” to “25”, and a hash value of the second block data BD2_1 that has previously been generated and a body part D that includes a hash value of a block data group formed from the first block data BD1 of the block IDs “21” to “25”.

Next, each calculation device 30 verifies whether it is allowed to connect the second block data BD2 generated in Step S121 to the block chain as a valid block using a known agreement algorithm (for example, “PoW: Proof of Work”, “PoS: Proof of Stake”, or the like). More specifically, one calculation device 40 transmits the second block data BD2 generated in Step S121 to another calculation device 40 (Step S122). Then, another calculation device 40 verifies the validity of the received second block data BD2 (Step S122A). For example, the other calculation device 40 verifies a connection between hash values of the second block data BD2 that was connected in the past as the block chain and the second block data BD2 that has been newly generated (received). In addition, the other calculation device 40 transmits a result of the verification representing whether or not the newly-generated second block data BD2 is to be approved as a valid block to one calculation device 40 (Step S122B).

Next, in a case in which results of the verification representing approval of the second block data BD2 have been received from a predetermined number (for example, 2/3) or more of calculation devices 40 (Step S123: Yes), the second block data generating unit 411 connects this second block data BD2 to the block chain as a latest block (Step S124). In addition, similarly, also in another calculation device 40, a process of connecting this second block data BD2 to the block chain as a latest block is performed (Step S124A). In accordance with this, the second block data BD2 is shared by the calculation devices 40 of the upper block chain 4.

On the other hand, in a case in which there are results of the verification indicating approval of the second block data BD2 less than the predetermined number (Step S123: No), the second block data generating unit 411 discards this second block data BD2 (Step S125).

In this way, the calculation device 40 of the upper block chain 4 performs the series of the processes described above every time when a registration request is accepted from the calculation device 30 of each of the plurality of lower block chains 3, thereby registering and sharing the second block data BD2 within the upper block chain 4. In addition, although FIG. 9 illustrates an example in which second block data BD2 is generated for one calculation device 40 belonging to the upper block chain 4, and the validity of the generated second block data BD2 is checked by another calculation device 40, the configuration is not limited thereto. In another embodiment, a plurality of calculation devices 40 may be formed to generate second block data BD2 in parallel. In such a case, one calculation device 40 that has generated second block data BD2 the earliest may be configured to transmit this second block data BD2 to another calculation device 40 and cause the other calculation device to check the validity.

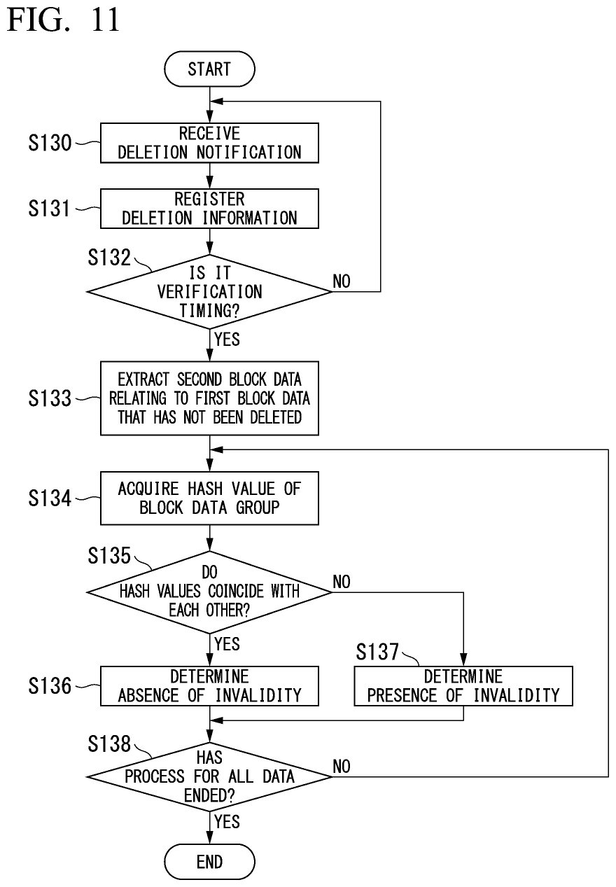

FIG. 11 is a second flowchart illustrating an example of a process of the upper block chain according to the first embodiment.

Hereinafter, an example of the verification process for the first block data BD1 in the upper block chain 4 will be described in detail with reference to FIG. 11.

First, as illustrated in FIG. 11, the data verifying unit 413 of the calculation device 40 of the upper block chain 4 receives a deletion notification for the first block data BD1 from the calculation device 30 of the lower block chain 3 (Step S130). Then, the data verifying unit 413 registers deletion information in which identification information (a lower block chain ID) of the lower block chain 3 for which deletion has been performed and a block ID of each of pieces of first block data BD1 that have been deleted are associated with each other on the basis of this deletion notification (Step S131). In addition, the data verifying unit 413 may register deletion information by causing the second block data generating unit 411 to generate second block data BD2 including this deletion information.

Next, the data verifying unit 413 determines whether it is a tuning for verifying the validity (presence or absence of an alteration) of the first block data BD1 (Step S132). For example, the data verifying unit 413 according to this embodiment is formed to perform verification for every predetermined time (for example, every one hour). In addition, in another embodiment, the data verifying unit 413 may be configured to perform verification when the second block data BD2 is generated.

In a case in which a predetermined time has not elapsed after previous verification (Step S132: No), the data verifying unit 413 returns the process to Step S130.

On the other hand, in a case in which a predetermined time has elapsed after previous verification (Step S132: Yes), the data verifying unit 413 extracts second block data BD2 relating to first block data BD1 that has not been deleted from the lower block chain 3 by referring to the deletion information (Step S133). For example, the data verifying unit 413 excludes second block data BD2 coinciding with a combination of a “lower block chain ID” and a “block ID” included in the deletion information as second block data BD2 other than a verification target by referring to header parts H of a plurality of pieces of second block data BD2. Then, the data verifying unit 413 extracts the other second block data BD2 as second block data BD2 that is a verification target.

Next, the hash acquiring unit 412 selects one piece of second block data BD2 in the second block data BD2 that is a verification target. Then, the hash acquiring unit 412 acquires a hash value of a block data group relating to the selected second block data BD2 from the calculation device 30 of the lower block chain 3 (Step S134). For example, the hash acquiring unit 412 identifies a lower block chain 3 in which the block data group is stored by referring to the “lower block chain ID” of the header part H of the second block data BD2. The hash acquiring unit 412 requests a hash value of a block data group formed from a plurality of pieces of first block data BD1 identified by the “block ID” of the header part H of the second block data BD2 from the calculation device 30 of the identified lower block chain 3. Then, the hash calculating unit 312 of the calculation device 30 of the lower block chain 3 that has received the request calculates a hash value of the block data group formed from the first block data BD1 corresponding to the designated “block ID” and outputs the calculated hash value to the calculation device 40 of the upper block chain 4.

Next, the data verifying unit 413 determines whether a hash value of the block data group included in the body part D of the selected second block data BD2 (a hash value relating to the first block data BD1 that has not been deleted) and a hash value of the block data group acquired by the hash acquiring unit 412 coincide with each other (Step S135).

In a case in which the two hash values coincide with each other (Step S135: Yes), the data verifying unit 413 determines that there is no invalidity (no alteration) in the first block data BD1 (Step S136).

On the other hand, in a case in which the two hash values do not coincide with each other (Step S135: No), the data verifying unit 413 determines that there is invalidity (there is an alteration) in the first block data BD1 (Step S137). At this time, for example, the data verifying unit 413 may notify the client 20 of the alteration of the first block data BD1. In this case, the data verifying unit 413 notifies the client 20 of identification information (a lower block chain ID) of the lower block chain in which there may be an alteration and a block ID of the first block data BD1.

Next, the data verifying unit 413 determines whether verification of all the second block data BD2 that is a verification target extracted in Step S133 has ended (Step S138). In a case in which there is second block data BD2 that has not been verified (Step S138: No), the data verifying unit 413 returns the process to Step S134 and performs each of the steps described above. On the other hand, in a case in which verification of all the second block data BD2 has ended (Step S138: Yes), the data verifying unit 413 ends the process.

By repeating the series of the processes described above constantly, the calculation device 40 of the upper block chain 4 verifies presence or absence of an alteration of the first block data BD1.

### Operation and Effect

As described above, the management system 1 according to this embodiment includes the calculation devices 30 of a plurality of the lower block chains 3 and the calculation device 40 of the upper block chain 4. Each of the calculation devices 30 of the plurality of the lower block chains 3 includes the data accepting unit 310 that accepts registration of the transaction data TD, the first block data generating unit 311 that generates first block data BD1 including the accepted transaction data TD, the hash calculating unit 312 that calculates a hash value of a block data group formed from at least one piece of first block data BD1, the registration requesting unit 313 that requests the calculation device 40 of the upper block chain 4 to register the hash value of the block data group, and the deletion processing unit 314 that deletes all the first block data BD1 of one lower block chain 3 at a predetermined timing. The calculation device 40 of the upper block chain 4 includes the registration accepting unit 410 that accepts a request for registering a hash value of a block data group from the calculation devices 30 of the plurality of the lower block chains 3, the second block data generating unit 411 that generates second block data BD2 including the hash value of the block data group that has been accepted, and the data verifying unit 413 that performs a determination process of determining presence or absence of invalidity of a plurality of pieces of first block data BD1 other than the deleted first block data BD1 on the basis of the hash value of the block data group included in the second block data BD2.

By configuring as such, the calculation device 40 of the upper block chain 4 stores only a hash value of a block data group formed from at least one piece of first block data BD1, and thus the data volume can be greatly reduced. In addition, the calculation device 40 of the upper block chain 4 can exclude the deleted first block data BD1 from verification targets and continuously perform verification of presence or absence of invalidity in a plurality of pieces of first block data BD1. In this way, the management system 1 can delete past data of the lower block chain 3 and thus can inhibit continuous expansion of the data volume and continuously perform data management for a long period in a state in which the security level of the whole system is maintained.

In addition, each of the calculation devices 30 of the plurality of the lower block chains 3 includes the notification processing unit 315 that notifies the calculation device 40 of the upper block chain 4 of deletion of the first block data BD1. The data verifying unit 413 of the calculation device 40 of the upper block chain 4 performs a determination process for a plurality of pieces of first block data BD1 other than the first block data BD1 of which the deletion has been notified by the notification processing unit 315.

By configuring as such, the data verifying unit 413 can identify the first block data BD1 that has not been deleted and perform a determination process only for first block data BD1 that has not been deleted as a target. Thus, even after all the first block data BD1 has been deleted for a certain lower block chain 3, the calculation device 40 of the upper block chain 4 can continuously perform the determination process for the first block chain BD1 of another lower block chain 3.

In addition, the second block data BD2 further includes a block ID that can be used for identifying the first block data BD1. The calculation device 40 of the upper block chain 4 further includes the hash acquiring unit 412 that acquires a hash value of a block data group including the first block data BD1 identified by the block ID from the calculation device 30 of the lower block chain 3. In a case in which the hash value of the block data group included in the second block data BD2 and the hash value of the corresponding block data group acquired by the hash acquiring unit 412 do not coincide with each other, the data verifying unit 413 determines that the first block data BD1 included in the corresponding block data group is invalid.

By configuring as such, the management system 1 can determine presence or absence of an alteration in the first block data BD1 easily and accurately by comparing the hash value of the block data group registered as the second block data BD2 and the hash value of the block data group actually stored in each calculation device 30 of the lower block chain 3 with each other.

In addition, at least each calculation device of at least two lower block chains 3 accepts the same transaction data TD from one client 20.

By configuring as such, in a case in which an alteration of the transaction data TD is performed, the first block data BD1 of each of at least two lower block chains 3 needs to be altered, and thus, the degree of difficulty in alteration can be further improved. In addition, even after the first block data BD1 has been deleted in one lower block chain 3 (for example, the lower block chain 3A), the management system 1 can cause the transaction data TD to remain in other lower block chains 3 (for example, the lower block chains 3B and 3C). In accordance with this, the management system 1 can extend a period in which the transaction data TD is stored. In addition, by differently setting deletion timings of the lower block chains 3, the management system 1 can control the period in which the transaction data TD is stored.

### Second Embodiment

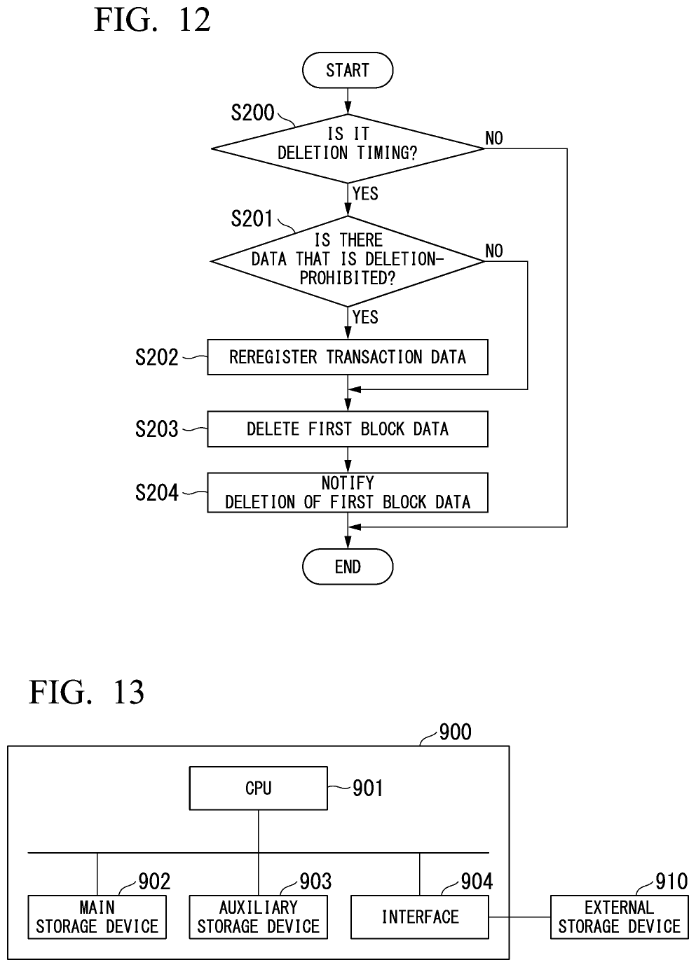

Next, a management system 1 according to a second embodiment of the present invention will be described with reference to FIG. 12.

The same reference signs will be assigned to constituent elements that are common to the first embodiment, and detailed description thereof will be omitted. In this embodiment, a process of deleting first block data BD1 in a calculation device 30 of a lower block chain 3 is different from that according to the first embodiment.

### Process Flow of Lower Block Chain

FIG. 12 is a flowchart illustrating an example of a process of a lower block chain according to the second embodiment.

Hereinafter, an example of a process of deleting transaction data TD for a calculation device 30 of a lower block chain 3 according to this embodiment will be described in detail with reference to FIG. 12. In the following description, an example in which a calculation device 30 of a lower block chain 3A performs a corresponding process will be described.

First, as illustrated in FIG. 12, a deletion processing unit 314 of the calculation device 30 of the lower block chain 3A determines whether it is a timing for deleting first block data BD1 (Step S200). This process is similar to the process according to the first embodiment (Step S110 illustrated in FIG. 8).

In a case in which a predetermined time has elapsed after the storage of latest first block data BD1 (Step S200: Yes), the deletion processing unit 314 determines whether or not information indicating deletion prohibition is registered in transaction data TD included in each of pieces of first block data BD1 shared by the lower block chain 3A.

For example, when registration of transaction data TD is accepted from a client 20 in Step S100 illustrated in FIG. 6, the data accepting unit 310 of the lower block chain 3A accepts selection of whether the transaction data TD is set to be deletion-prohibited. In addition, a data accepting unit 310 may further accept designation of a period in which deletion is prohibited from the client 20. Information indicating whether deletion is prohibited and information representing a period of deletion prohibition are assumed to be included in the transaction data. In addition, in a period until first block data BD1 including the transaction data TD is deleted after the first block data BD1 is registered, the data accepting unit 310 may be allowed to be constantly able to accept editing of the information indicating deletion prohibition or no deletion prohibition of the transaction data TD and the information representing the period of the deletion prohibition. In this case, the data accepting unit 310 may store a table in which a “transaction ID” that can be used for identifying transaction data TD and information representing deletion prohibition or non-deletion prohibition and the period of deletion prohibition are associated with each other in a storage medium 33.

In a case in which there is no transaction data TD in which information indicating deletion prohibition is registered by referring to a body part D of the first block data BD1 (Step S202: No), a deletion processing unit 314 causes the process to proceed to Step S203. In addition, in a case in which there is transaction data TD in which information indicating deletion prohibition is registered, and the period designated for deletion prohibition is before the current date and time, the deletion processing unit 314 determines that this transaction data TD is not deletion prohibited. Furthermore, in a case in which the information representing deletion prohibition or no deletion prohibition and the period of deletion prohibition is managed in a table, the deletion processing unit 314 may be configured to identify transaction data TD that is deletion prohibited by referring to the table.

On the other hand, in a case in which there is transaction data TD in which information indicting deletion prohibition is registered and a case in which the period designated for deletion prohibition is after the current date and time (Step S202: Yes), the deletion processing unit 314 reregisters this transaction data TD in another lower block chain 3 (Step S202). In addition, in this embodiment, the deletion processing unit 314 is assumed to request other two lower block chains 3B and 3C to reregister transaction data TD.

In addition, in a case in which reregistration of the transaction data TD in the other lower block chains 3B and 3C is performed, the deletion processing unit 314 may assign a new transaction ID and causes the lower block chains 3B and 3C to transmit registration requests. In addition, the deletion processing unit 314 may request the client 20 to reregister the transaction data TD. In such a case, the client 20 assigns a new transaction ID to this transaction data TD and requests the lower block chains 3B and 3C to register the transaction data.

Next, the deletion processing unit 314 deletes all the first block data BD1 shared among the calculation devices 30 of the lower block chain 3A (Step S203). This process is similar to the process (Step S111 illustrated in FIG. 8) according to the first embodiment.

Next, a notification processing unit 315 notifies the calculation device 40 of the upper block chain 4 of deletion of all the first block data BD1 of the lower block chain 3A (Step S204). This process is similar to the process (Step S112 illustrated in FIG. 8) according to the first embodiment.

Each of the calculation devices 30 of the plurality of the lower block chains 3 performs deletion of all the first block data BD1 at a predetermined tuning by repeatedly performing the series of the processes described above constantly and performs a process or reregistering the transaction data TD that is deletion prohibited as new transaction data.

In addition, in the example described above, although a form in which the data accepting unit 310 accepts the information indicating deletion prohibition and the information representing the period of deletion prohibition from the client 20 has been described, the configuration is not limited thereto. In another embodiment, the data accepting unit 310 may automatically add information indicating deletion prohibition to transaction data TD on the basis of “transaction details” of the transaction data TD. For example, in a case in which the amount of money included in the transaction details exceeds a predetermined amount (for example, 5 million Yen), the data accepting unit 310 adds the information indicating deletion prohibition to the corresponding transaction data TD. In addition, the data accepting unit 310 may further add information representing a period of deletion prohibition in accordance with the amount of money. Furthermore, in a case in which a transaction target, a user, and the like, which are determined in advance, are included in transaction data TD, the data accepting unit 310 may add information indicating deletion prohibition to this transaction data TD.

### Operation and Effect

As described above, in the management system 1 according to this embodiment, when first block data BD1 is to be deleted, the calculation device 30 of one lower block chain 3 requests the calculation device 30 of another lower block chain 3 to register transaction data TD satisfying a predetermined condition as new transaction data TD.

By configuring as such, the management system 1 can cause significant transaction data TD such as data desired not to be deleted by a user, data of which the transaction amount of money is large, and the like to remain in the calculation device 30 of another lower block chain 3 as new transaction data TD.

In addition, the data accepting unit 310 further accepts registration of information indicating deletion prohibition or no deletion prohibition of the transaction data TD, and the deletion processing unit 314 determines that a predetermined condition is satisfied in a case in which the information indicating deletion prohibition is registered in the transaction data TD.

By configuring as such, the management system 1 can cause transaction data TD designated not to be deleted by a user to remain in the lower block chain 3 as new transaction data TD. In addition, acceptance of registration of the information indicating deletion prohibition or no deletion prohibition may be performed at the time of registering the transaction data TD or may be performed after the registration. In this way, a user can change handling of deletion prohibition or no deletion prohibition of transaction data TD in a more flexible manner.

### Hardware Configuration

FIG. 13 is a diagram illustrating an example of the hardware configuration of a calculation device according to at least one of the embodiments.

Hereinafter, an example of the hardware configuration of the calculation device 30 of the lower block chain 3 and the calculation device 40 of the upper block chain 4 described above will be described with reference to FIG. 13.

As illustrated in FIG. 13, a computer 900 includes a CPU 901, a main storage device 902, an auxiliary storage device 903, and an interface 904.

Each of the calculation device 30 and the calculation device 40 described above is mounted in the computer 900. The operation of each processing unit described above is stored in the auxiliary storage device 903 in the form of a program. The CPU 901 (the CPU 31 of the calculation device 30 and the CPU 41 of the calculation device 40) reads the program from the auxiliary storage device 903, expands the program in the main storage device 902, and executes the process described above in accordance with the program. In addition, the CPU 901 secures a storage area used for various processes by the calculation device 30 and the calculation device 40 in the main storage device 902 in accordance with the program. Furthermore, the CPU 901 secures a storage area (the storage medium 33 of the calculation device 30 and the storage medium 43 of the calculation device 40) storing data during processing in the auxiliary storage device 903 in accordance with the program.

Examples of the auxiliary storage device 903 includes a hard disk drive (HDD), a solid state drive (SSD), a magnetic disk, a magneto-optical disk, a compact disc read only memory (CD-ROM), a digital versatile disc read only memory (DVD-ROM), a semiconductor memory, and the like. The auxiliary storage device 903 may be an internal medium directly connected to a bus of the computer 900 or an external medium connected to the computer 900 through the interface 904 or a communication line. In addition, in a case in which this program is distributed to the computer 900 through a communication line, the computer 900 that has received the distributed program may expand the program into the main storage device 902 and execute the process described above. In at least one of the embodiments, the auxiliary storage device 903 is a non-transitory storage medium.

In addition, the program may be used for realizing some of the functions described above. Furthermore, the program may be so-called a differential file (differential program) that realizes the function described above by being combined with another program stored in the auxiliary storage device 903 in advance.

While preferred embodiments according to the present invention have been described as above, all these embodiments are presented as examples and are not intended to limit the scope of the invention. Such embodiments can be performed in other various forms, and various omissions, substitutions, and modifications can be made without in a range not departing from the concept of the invention. Similar to such embodiments and modifications thereof being included in the scope and the concept of the invention, they are included in the invention described in claims and the scope of equivalency thereof.

### INDUSTRIAL APPLICABILITY

According to at least one of the aspects described above, past data can be deleted, and data management can be continuously performed for a long period in a state in which the security level is maintained.

### REFERENCE SIGNS LIST

1 Management system

20 Client

3, 3A, 3B, 3C Lower block chain

30 Calculation device

31 CPU

310 Data accepting unit

311 First block data generating unit

312 Hash calculating unit

313 Registration requesting unit

314 Deletion processing unit

315 Notification processing unit

32 Communication VF

33 Storage medium

4 Upper block chain

40 Calculation device

41 CPU

410 Registration accepting unit

411 Second block data generating unit

412 Hash acquiring unit

413 Data verifying unit

42 Communication VF

43 Storage medium

1. A management system comprising:
calculation devices of a plurality of lower block chains; and
a calculation device of an upper block chain,
wherein each of the calculation devices of the plurality of the lower block chains includes:
a data accepting unit configured to accept registration of transaction data;
a first block data generating unit configured to generate first block data including the accepted transaction data;
a hash calculating unit configured to calculate a hash value of a block data group formed from at least one piece of the first block data;
a registration requesting unit configured to request registration of the hash value of the block data group to the calculation device of the upper block chain; and
a deletion processing unit configured to delete all the first block data of one of the lower block chains at a predetermined timing, and
wherein the calculation device of the upper block chain includes:
a registration accepting unit configured to accept a registration request for registering the hash value of the block data group from the calculation devices of the plurality of the lower block chains;
a second block data generating unit configured to generate second block data including the accepted hash value of the block data group; and
a data verifying unit configured to perform a determination process of determining presence or absence of invalidity in a plurality of pieces of the first block data other than deleted first block data on the basis of the hash value of the block data group included in the second block data.

2. The management system according to claim 1,
wherein each of the calculation devices of the plurality of the lower block chains includes a notification processing unit configured to notify the calculation device of the upper block chain of deletion of the first block data, and
wherein the data verifying unit of the calculation device of the upper block chain performs the determination process for a plurality of pieces of the first block data other than the first block data of which deletion has been notified by the notification processing unit.

3. The management system according to claim 1,
wherein the second block data further includes a block ID that can be used for identifying the first block data,
wherein the calculation device of the upper block chain further includes a hash acquiring unit configured to acquire the hash value of the block data group including the first block data identified by the block ID from the calculation device of the lower block chain, and
wherein, in a case in which the hash value of the block data group included in the second block data and the hash value of the corresponding block data group acquired by the hash acquiring unit do not coincide with each other, the data verifying unit determines that the first block data included in the corresponding block data group is invalid.

4. The management system according to claim 1, wherein each of the calculation devices of at least two lower block chains accepts the same transaction data.

5. The management system according to claim 1, wherein, when the first block data is deleted, the calculation device of one of the lower block chains requests registration of the transaction data satisfying a predetermined condition to the calculation device of another lower block chain as new transaction data.

6. The management system according to claim 5, wherein each of the calculation devices of the plurality of the lower block chains further accepts registration of information indicating deletion prohibition or non-deletion prohibition of the transaction data and determines that the condition is satisfied in a case that the information indicating deletion prohibition is registered for the transaction data.

7. A management method using calculation devices of a plurality of lower block chains and a calculation device of an upper block chain, the management method comprising:
steps performed by each of the calculation devices of the plurality of the lower block chains, the steps including:
accepting registration of transaction data;
generating first block data including the accepted transaction data;
calculating a hash value of a block data group formed from at least one piece of the first block data;
requesting the calculation device of the upper block chain to register the hash value of the block data group; and
deleting all the first block data at a predetermined timing, and
steps performed by the calculation device of the upper block chain, the steps including:
accepting a registration request for registering the hash value of the block data group from the calculation devices of the plurality of the lower block chains;
generating second block data including the accepted hash value of the block data group; and
determining presence or absence of invalidity in a plurality of pieces of the first block data other than deleted first block data on the basis of the hash value of the block data group included in the second block data.

8. A calculation device of an upper block chain comprising:
a registration accepting unit configured to accept a registration request for registering a hash value of a block data group formed from at least one piece of first block data including transaction data accepted by a calculation device of a lower block chain;
a second block data generating unit configured to generate second block data including the accepted hash value of the block data group; and
a data verifying unit configured to determine presence/absence of invalidity in a plurality of pieces of the first block data other than deleted first block data on the basis of the hash value relating to the first block data included in the second block data.

9. (canceled)
